(19) United States
(12) Patent Application Publication
(10) Pub. No.: US 2025/0347079 A1
(43) Pub. Date: Nov. 13, 2025

(54) HYDRAULIC QUICK COUPLER DECOMPRESSION TOOL

(71) Applicant: Preston Haines Thomas, San Luis Obispo, CA (US)

(72) Inventor: Preston Haines Thomas, San Luis Obispo, CA (US)

(21) Appl. No.: 19/202,998

(22) Filed: May 8, 2025

Related U.S. Application Data
(60) Provisional application No. 63/644,933, filed on May 9, 2024.

(51) Int. Cl. E02F 3/36; B25B 27/02

(52) U.S. Cl. CPC E02F 3/3672; B25B 27/023

(57) ABSTRACT

A system, method, and apparatus for opening a coupler and releasing pressure in a hydraulic circuit comprises an upper brace, a lower brace, a cutout formed in the lower brace, and a plunger release engaged with the upper brace and aligned with the cutout in the lower brace, where the plunger release further comprises a handle, a threaded shaft extending from the handle, and a release socket on an end of the threaded shaft.

### CROSS REFERENCE TO RELATED PATENT APPLICATIONS

This patent application claims the priority and benefit under 35 U.S.C. § 119(e) of U.S. Provisional Patent Application Ser. No. 63/644,933 filed May 9, 2024, entitled “HYDRAULIC QUICK COUPLER DECOMPRESSION TOOL.” U.S. Provisional Patent Application Ser. No. 63/644,933 is herein incorporated by reference in its entirety.

### TECHNICAL FIELD

Embodiments are generally related to the field of tools. Embodiments are also related to the field of tools for hydraulic fittings. Embodiments are further related to the field of tools for tractors, skid steers, and excavators. Embodiments are further related to tools for hydraulic decompression for flat faced ISO 16028 male and female quick couplers.

### BACKGROUND

Hydraulic-based heavy machinery such as tractors, skid steers, and excavators use quick couplers for connecting to the hydraulic systems. In such systems, power can be transmitted and controlled with a fluid under pressure. The fluid under pressure is contained in a closed loop, so that applying pressure at one point can transfer the associated power to another point in the closed loop. In such systems quick couplers are used to allow an operator to quickly and easily connect or disconnect hydraulic lines.

One example of such a coupler is the female hydraulic quick coupler, which is an International Standards Organization (ISO) 16028 conforming coupler. This type of coupler 100 has a flat face, and is illustrated in FIG. 1A, labeled as prior art.

Quick couplers are meant to be easy to use, so that users can quickly connect or disconnect lines to a hydraulic pressure circuit. However, in practice, the hydraulic circuit is under pressure. As such, it can be very difficult to attach a hydraulic line using a quick connect if there is pressure still in the line.

One solution is to release the pressure in the hydraulic circuit before attempting to connect a line. However, the quick coupler has a flat face and small area to compress, which makes it very difficult to release the pressure, particularly by hand.

As such, there is a need in the art for simple, cost effective systems, methods, and tools for releasing pressure via a quick coupler, as disclosed herein.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the disclosed embodiments to provide a tool.

It is another aspect of the disclosed embodiments to provide a tool for quick connect couplers.

It is another aspect of the disclosed embodiment to provide a tool for releasing pressure in a hydraulic circuit via a quick connect coupler.

It is another aspect of the disclosed embodiments to provide a method and system or apparatus for interfacing with a quick connect coupler to release pressure.

In an exemplary embodiment a tool comprises an upper brace, a lower brace, a cutout formed in the lower brace, and a plunger release engaged with the upper brace and aligned with the cutout in the lower brace. In an embodiment, the tool further comprises at least one support stand affixed on one end to the upper brace and affixed on the other end to the lower brace. In an embodiment, the tool further comprises a threaded plunger release port in the upper brace configured to accept the plunger release. In an embodiment, the tool further comprises at least one threaded clamp engaged with the lower brace and configured to tighten the cutout around a coupler. In an embodiment, the plunger release further comprises a handle, a threaded shaft extending from the handle, and a release socket on an end of the threaded shaft. In an embodiment, the release socket comprises a tubular body and a rim. In an embodiment, the rim of the release socket is sized to match a release ring of a coupler. In an embodiment, an overflow port configured on the tubular body of the release socket. In an embodiment, the lower brace further comprises a first side brace and a second side brace. In an embodiment, the tool includes a first inner edge profile with a partial circle cutout formed on the first side brace and a second inner edge profile with a partial circle cutout formed on the second side brace. In an embodiment, the first side brace and the second side brace are connected with at least one threaded clamp engaged with the lower brace and configured to tighten the cutout around a coupler.

In an embodiment, a tool comprises an upper brace, a lower brace, a cutout formed in the lower brace, the cutout being sized to engage a neck of a quick coupler, and a plunger release engaged with the upper brace and aligned with the cutout in the lower brace. In an embodiment, the plunger release is configured to engage a connection face of the quick coupler. In an embodiment, the quick coupler comprises an International Standards Organization (ISO) 16028 conforming coupler. In an embodiment, the tool further comprises a threaded plunger release port in the upper brace configured to accept the plunger release. In an embodiment, the tool further comprises at least one threaded clamp engaged with the lower brace and configured to tighten the cutout around the neck of the quick coupler. In an embodiment, the plunger release further comprises a handle, a threaded shaft extending from the handle, and a release socket on an end of the threaded shaft, wherein a diameter of a rim of the release socket is sized to nominally match a diameter of a release ring of the quick coupler. In an embodiment, the tool further comprises an overflow port configured on the release socket. In an embodiment, the lower brace further comprises a first side brace, and a second side brace, wherein the first side brace and the second side brace are connected with at least one threaded clamp engaged with the lower brace and configured to tighten the cutout around the quick coupler.

In an embodiment, a system comprises an upper brace, a lower brace, a cutout formed in the lower brace, the cutout being sized to engage a neck of a comprises an International Standards Organization (ISO) 16028 conforming coupler, and a plunger release engaged with the upper brace and aligned with the cutout in the lower brace

The aforementioned aspects and other objectives and advantages can now be achieved as described herein.

### BRIEF DESCRIPTION OF THE FIGURES

The accompanying figures, in which like reference numerals refer to identical or functionally similar elements throughout the separate views and which are incorporated in, and form a part of the specification, further illustrate the embodiments and, together with the detailed description, serve to explain the embodiments disclosed herein.

FIG. 1A depicts a view of a prior art quick connect coupler, in accordance with the disclosed embodiments;

FIG. 1B depicts another view of a prior art quick connect coupler, in accordance with the disclosed embodiments;

FIG. 2A depicts a top front perspective view of a tool, in accordance with the disclosed embodiments;

FIG. 2B depicts a bottom view of a tool, in accordance with the disclosed embodiments;

FIG. 2C depicts a top rear perspective view of a tool, in accordance with the disclosed embodiments;

FIG. 2D depicts a side view of a tool, in accordance with the disclosed embodiments;

FIG. 3A depicts a side perspective view of a tool engaged to a coupler, in accordance with the disclosed embodiments;

FIG. 3B depicts a front elevation view of a tool engaged to a coupler, in accordance with the disclosed embodiments;

FIG. 3C depicts a side perspective view of a tool engaged to a coupler, in accordance with the disclosed embodiments;

FIG. 3D depicts a side perspective view of a tool engaged to a coupler, in accordance with the disclosed embodiments;

FIG. 4A illustrates a side perspective view of a tool, in accordance with the disclosed embodiments;

FIG. 4B illustrates an elevation view of the tool, in accordance with the disclosed embodiments;

FIG. 4C illustrates a bottom perspective view of the tool, in accordance with the disclosed embodiments;

FIG. 4D illustrates a top side perspective view of the tool, in accordance with the disclosed embodiments; and

FIG. 5 depicts steps associated with a method for opening a coupler and releasing pressure in a hydraulic circuit, in accordance with the disclosed embodiments.

### DETAILED DESCRIPTION

The particular values and configurations discussed in the following non-limiting examples can be varied, and are cited merely to illustrate one or more embodiments and are not intended to limit the scope thereof.

Example embodiments will now be described more fully hereinafter with reference to the accompanying drawings, in which illustrative embodiments are shown. The embodiments disclosed herein can be embodied in many different forms and should not be construed as limited to the embodiments set forth herein; rather, these embodiments are provided so that this disclosure will be thorough and complete, and will fully convey the scope of the embodiments to those skilled in the art. Like numbers refer to like elements throughout.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context. All aspects of the various embodiments can be interchangeable with aspects disclosed in other embodiments, and/or can be incorporated in other embodiments.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope and concept of the invention as defined by the appended claims.

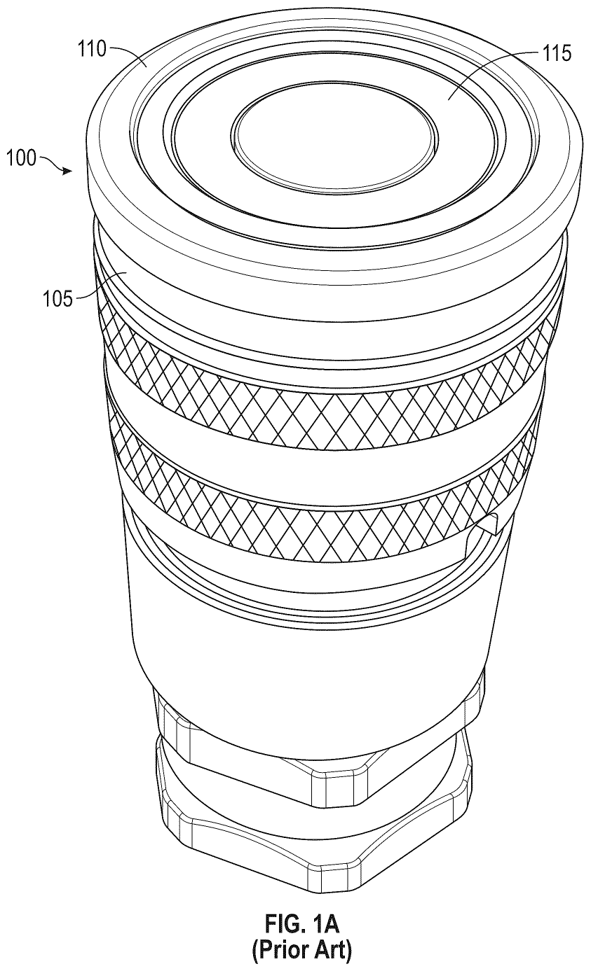

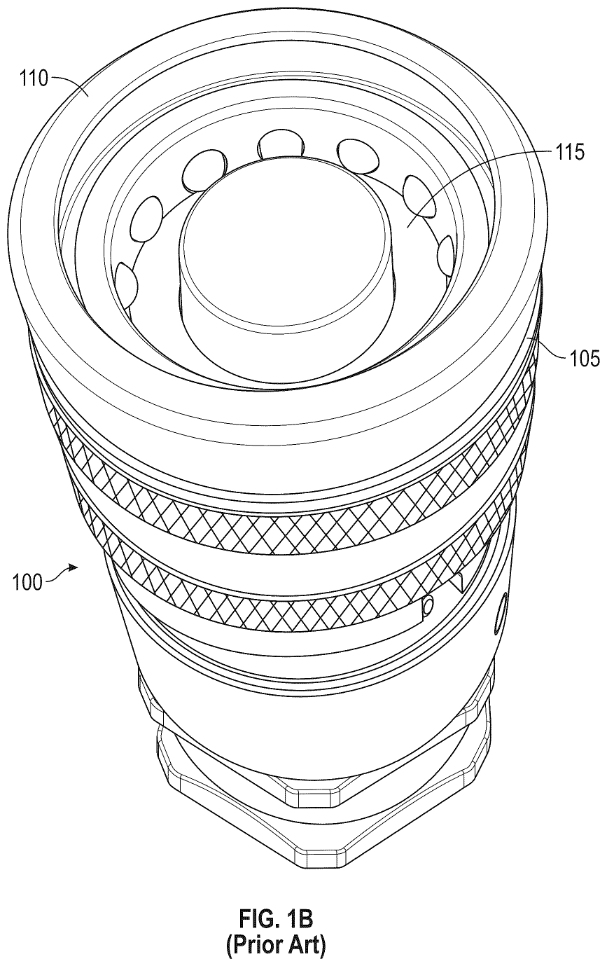

FIG. 1A illustrates an exemplary prior art coupler 100 (or “quick coupler”). The disclosed embodiments can be used to release pressure in a hydraulic circuit fitted with such a coupler. The coupler 100 can comprise a neck 105, and a connection face 110. The connection face 110 can further include a release ring 115. When the release ring 115 is not depressed, the coupler 100 is “closed”, allowing the hydraulic circuit to remain under pressure. When the release ring 115 is depressed, the coupler is “open” meaning fluid can flow through the coupler. In normal operation a male fitting, for example associated with a fluid line, can be engaged to the coupler 100. When the male fitting is engaged, the coupler 100 is opened so that fluid can flow into, or out of, the associated hydraulic circuit.

FIG. 1B illustrates the exemplary prior art coupler 100 with the release ring 115 depressed such that the coupler is in an “open” state.

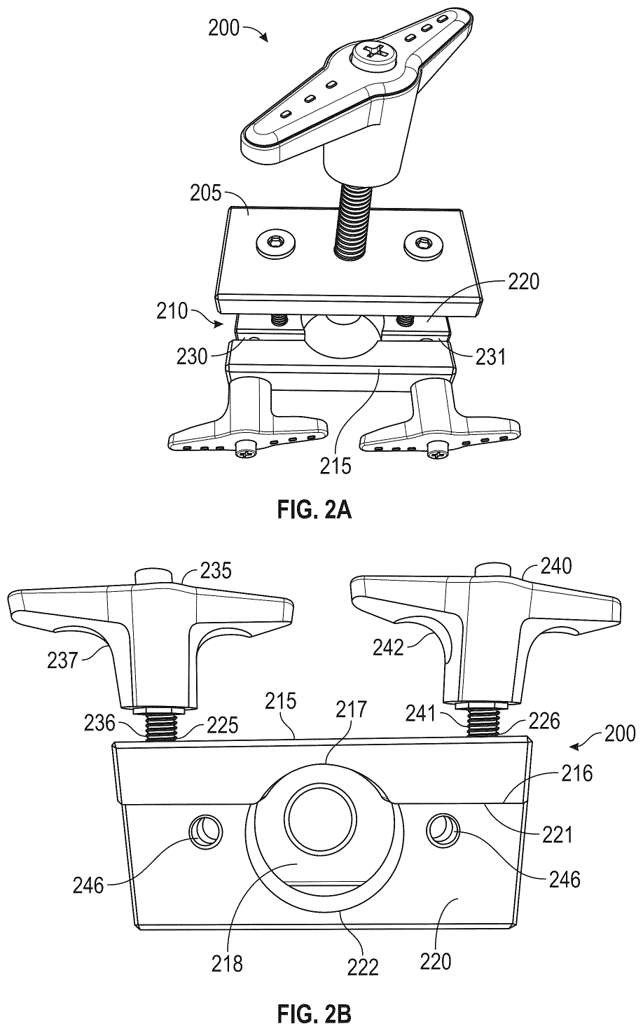

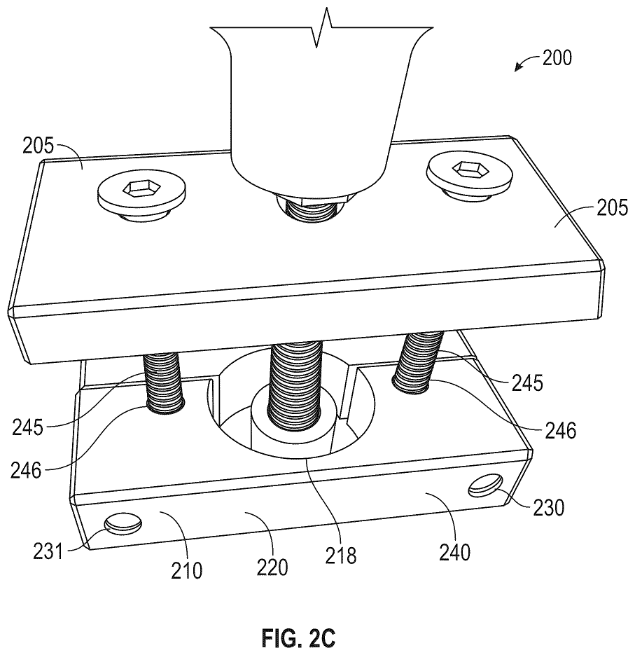

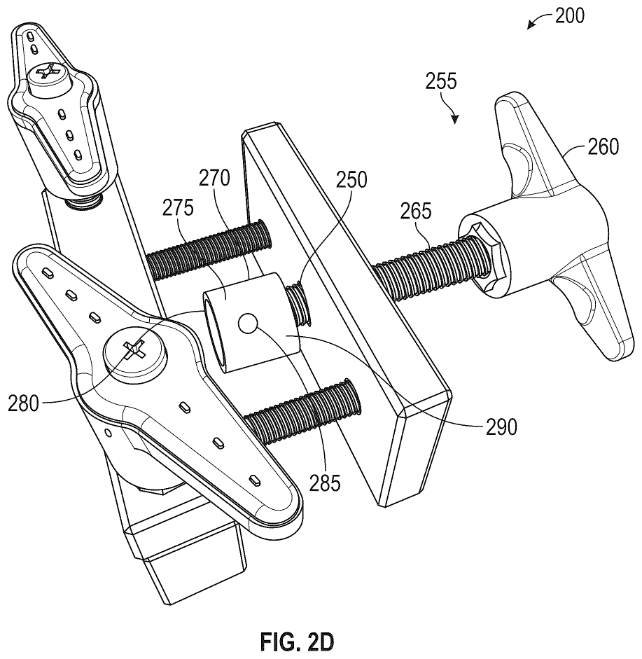

FIG. 2A illustrates a tool 200 in accordance with the disclosed embodiments. The tool 200 generally comprises an upper brace 205, and a lower brace 210. The lower brace 210 can further comprise two pieces, a first side brace 215 and a second side brace 220.

FIG. 2B illustrates a bottom view of the tool 200. The first side brace 215 includes an inner edge profile 216 with a partial circle cutout 217. The second side brace 220 includes an inner edge profile 221 with a partial circle cutout 222. The first side brace 215 can further include a first clamp hole 225 extending through the first side brace 215, and a second clamp hole 226 extending through the first side brace 215. In certain embodiments, the first clamp hole 225 and the second clamp hole 226 can be positioned laterally so that they do not intersect the partial circle cutout 217. The first clamp hole 225 and the second clamp hole 226 can be configured with female threading.

As illustrated in FIG. 2C, the second side brace 220 can include a first threaded receiver port 230 and a second threaded receiver port 231. The first threaded receiver port 230 on the second side brace 220 is positioned to be aligned with the first clamp hole 225 on the first side brace 215. The second threaded receiver port 231 on the second side brace is positioned to be aligned with the second clamp hole 226 on the first side brace 215.

The tool 200 can include a first threaded clamp 235. The first threaded clamp 235 comprises a threaded shaft 236 and handle 237. The shaft 236 of the first threaded clamp 235 is sized to be inserted through the first clamp hole 225, and into threaded engagement with the first threaded receiver port 230.

The tool 200 can also include a second threaded clamp 240. The second threaded clamp 240 comprises a threaded shaft 241 and handle 242. The shaft 241 of the second threaded clamp 240 is sized to be inserted through second clamp hole 226, and into threaded engagement with the second threaded receiver port 231.

When the first threaded clamp 235 and second threaded clamp 240 are tightened, the partial circle cutout 217 and the partial circle cutout 222 are brought toward one another forming a cutout 218 with a size and shape mirroring the exterior profile of the neck 105 of a coupler 100.

FIG. 2C illustrates a perspective view of the tool 200. As illustrated, the upper brace 205 and lower brace 210 can be separated with a set of support stands 245. In some embodiments, the support stands 245 can comprise threaded bolts configured to engage threaded support stand ports 246 in the second side brace 220, which allows the relative distance between the upper brace 205 and lower brace 210 to be adjusted. However, in other embodiments, the support stands 245 can comprise other rigid structures configured to establish a spaced relationship between the upper brace 205 and lower brace 210.

The upper brace 205 can further include a threaded plunger release port 250, as illustrated in FIG. 2D. The threaded plunger release port 250 is located on the upper brace 205 to be nominally aligned with the center of the cutout formed by the partial circle cutout 217 and the partial circle cutout 222 forming a cutout with a size and shape matching the exterior profile of the neck of a coupler 100.

FIG. 2D illustrates a side perspective view of the tool 200. The tool 200 further comprises a plunger release 255. The plunger release 255 generally comprises a threaded shaft 265 connected on one end to a handle 260. On the opposite end, the shaft 265 is connected to a release socket 270.

The release socket 270 can comprise a generally tubular body 275 attached on one end to the shaft 265, and having an open operating end, forming a rim 280. The diameter of the rim 280 can be selected to nominally match the diameter of the release ring 115 of the coupler 100. The body 275 of the release socket 270 can further comprise an overflow port 285 on the sidewall 290 of the body 275.

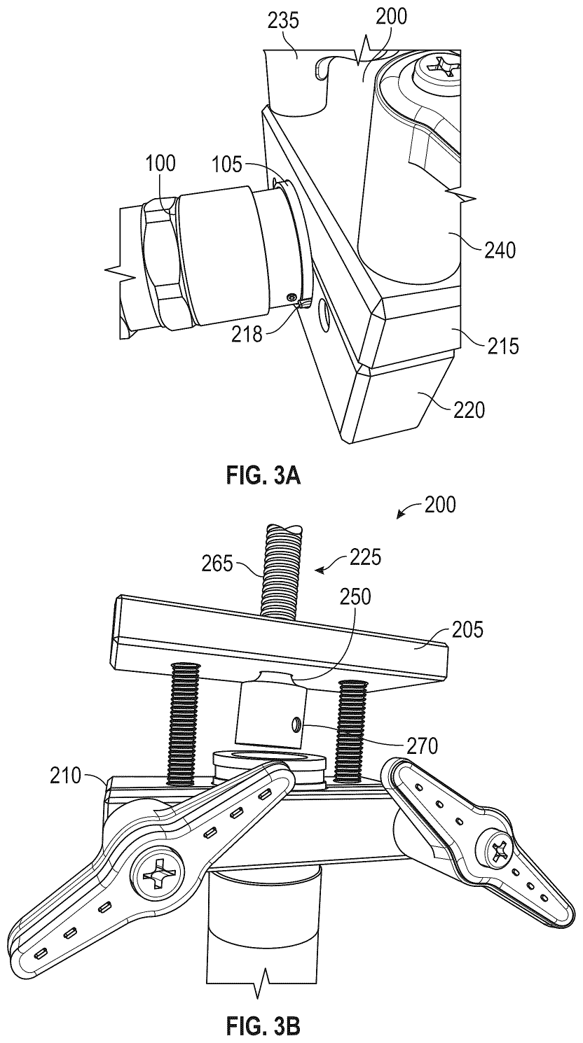

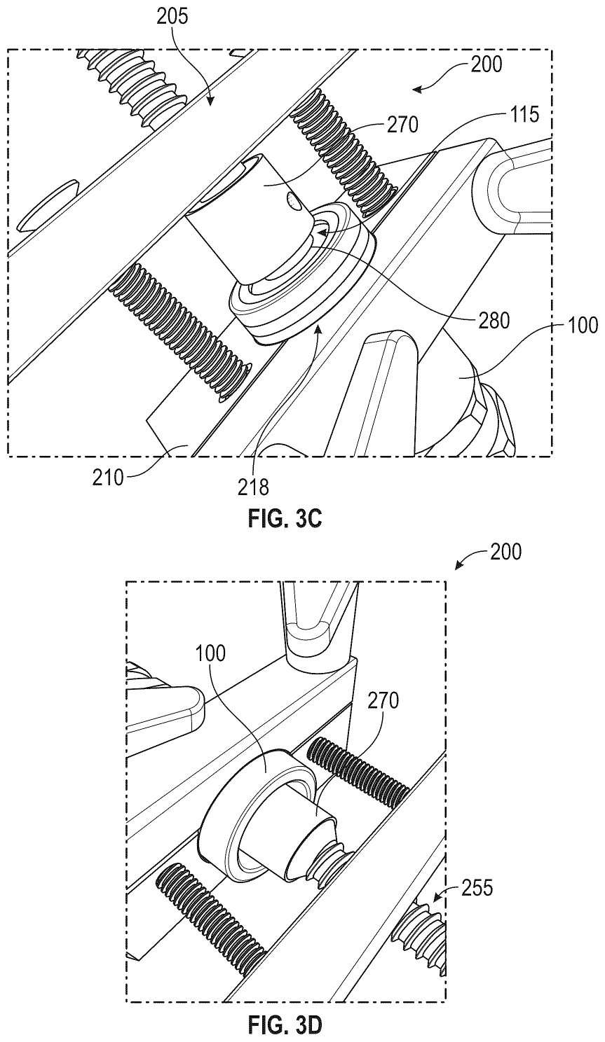

FIGS. 3A-3D illustrate the tool 200 as it is applied to a coupler 100. In operation, the tool 200 is used to engage a coupler, such as coupler 100. The cutout 218 in the lower brace 210 can be inserted over the neck 105 of the coupler 100. Once the tool 200 is in place it can be secured by tightening the cutout 218 around the coupler 100 by tightening the first threaded clamp 235 and second threaded clamp 240.

Once the tool 200 is securely engaged to the coupler 100, the release plunger 255 can be used to depress the release ring 115 of the coupler 100. This can be achieved by turning the handle 260 of the release plunger 255, such that the threaded shaft 265 turns in the plunger release port 250 driving the release socket 270 toward the face 110 of the coupler 100, as shown in FIG. 3B.

The diameter of the release socket 270 is specifically selected to match the release ring 115 in the coupler 100, as shown in FIG. 3C. When the release socket 270 contacts the face 110 of the coupler 100 the rim 280 of the release socket 270 will be in contact with the release ring 115 in the coupler 100. It is important to note that the rim 280 of the release socket 270 must be sized to match the release ring 115 in the coupler 100, so that the tool 100 only depresses the release ring 115 and not other surfaces of the coupler face 110. If the rim 280 is too big or too small it will not depress the release ring 115 properly and the coupler 100 will not open.

The alignment is ensured by the relative location of the cutout 218 in the lower brace 210 engaged with the coupler neck 105, and the location of the plunger release 255 through the threaded plunger release port 250.

The release socket 270 can apply pressure to the release ring 115 by operation of the release plunger 255. By continuing to turn the handle of the release plunger 255, the release socket 270 is driven into the release ring 115. The threaded engagement allows pressure to be applied incrementally, until sufficient pressure is applied to the release ring 115 in the coupler 100, that the pressure in the hydraulic circuit is released through the coupler 100 as illustrated in FIG. 3D.

The hydraulic circuit may be filled with a liquid such as hydraulic fluid, oil, water or the like. Since the hydraulic circuit is under pressure, when the pressure is released, the pressure differential between the exterior environment and the hydraulic circuit will force some of the hydraulic fluid out of the coupler. The excess fluid can escape through the overflow port 285 on the release socket 270.

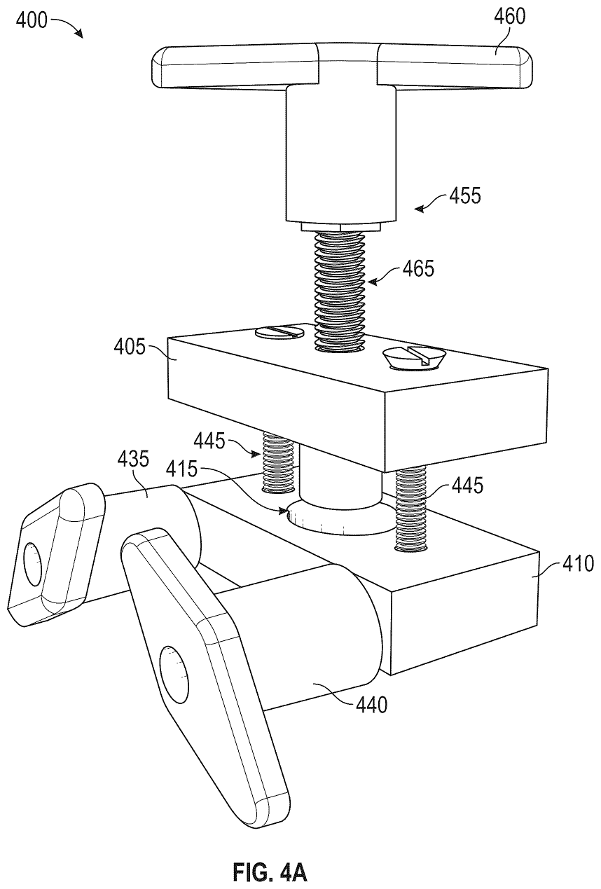

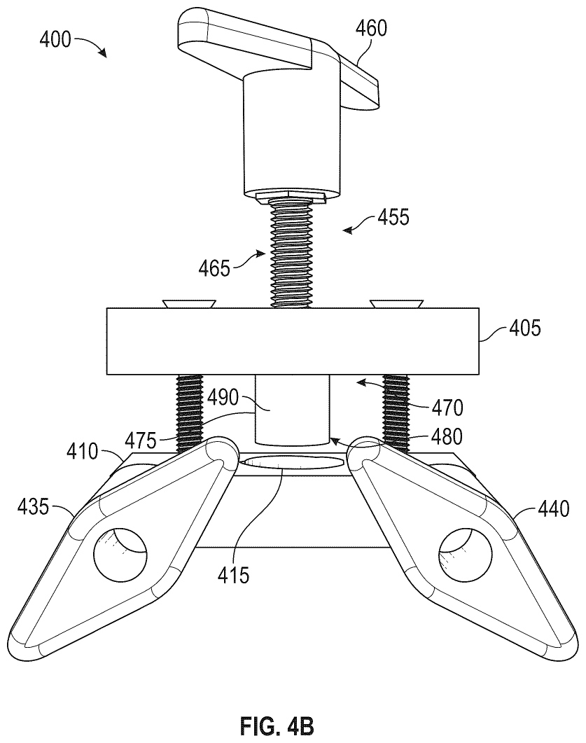

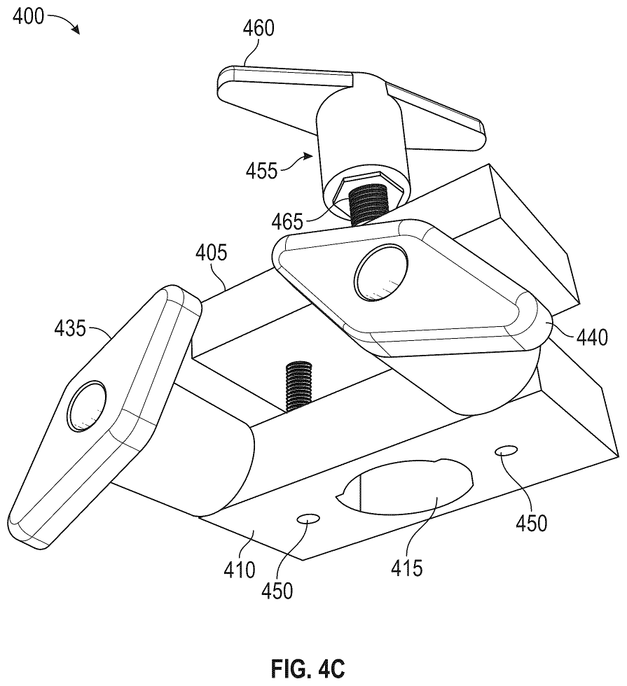

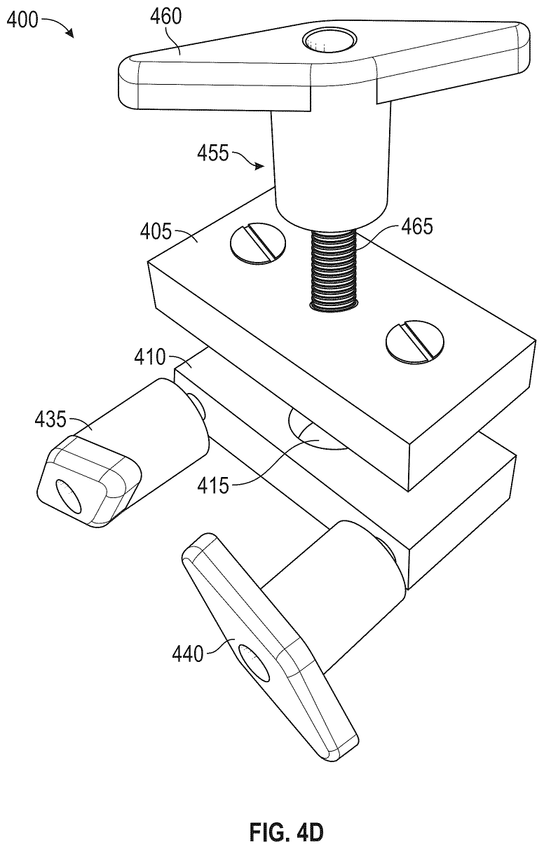

FIGS. 4A-4D illustrate another embodiment of a tool 400 in accordance with the disclosed embodiments. The tool 400 includes various aspects which are functionally equivalent to those illustrated in FIGS. 4A-4D. FIG. 4A illustrates a side perspective view of the tool 400, FIG. 4B illustrates an elevation view of the tool 400, FIG. 4C illustrates a bottom perspective view of the tool 400, and FIG. 4D illustrates a top side perspective view of the tool 400.

The tool 400 comprises an upper brace 405, and a lower brace 410. The lower brace 410 includes a tubular cutout 415 configured to accept the neck 105 of a coupler 100. A first threaded clamp 435 and second threaded clamp 440 are used to tighten the tubular cutout 415 around the neck 105 of the coupler 100.

As illustrated, the upper brace 405 and lower brace 410 can be separated with a set of support stands 445. In some embodiments, the support stands 445 can comprise threaded bolts or screws configured to engage threaded support stand ports 450 in the lower brace 410, which allows the relative distance between the upper brace 405 and lower brace 410 to be adjusted. However, in other embodiments, the support stands 445 can comprise other rigid structures configured to establish a spaced relation between the upper brace 405 and lower brace 410.

The upper brace 405 can further include a threaded plunger release port 420. The threaded plunger release port 420 is located on the upper brace 405 to be nominally aligned with the tubular cutout 415.

The tool 400 further comprises a plunger release 455. The plunger release 455 generally comprises a threaded shaft 465 connected on one end to a handle 460. On the opposite end, the shaft 465 is connected to a release socket 470.

The release socket 470 can comprise a generally tubular body 475 with an open operating end, forming a rim 480. The diameter of the rim 480 can be selected to match the diameter of the release ring of the coupler 100. The body 475 of the release socket 470 can further comprise an overflow port on the sidewall 490 of the body 475.

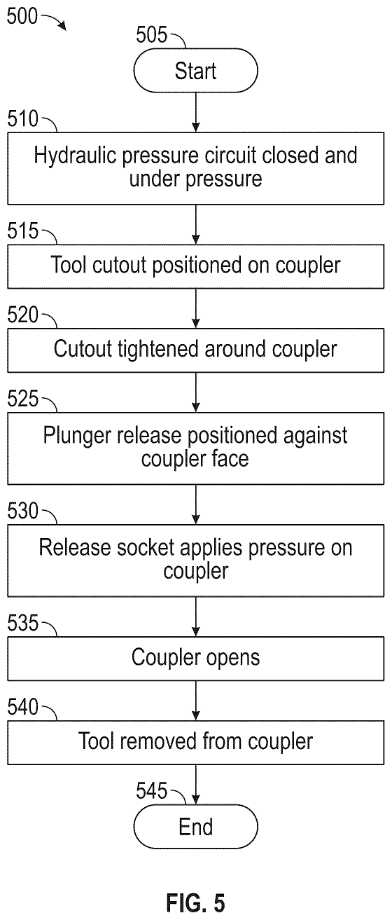

FIG. 5 illustrates a method 500 for “opening” a coupler, such as quick coupler 100, and releasing pressure in a hydraulic circuit, in accordance with the disclosed embodiments. The method starts at 505.

At step 510, the hydraulic pressure circuit is “closed”, and the associated coupler connected to the hydraulic pressure circuit is in a closed position. In this configuration pressure in the hydraulic circuit is maintained, and fluid is prevented from flowing in or out of the coupler.

At step 515, a tool such as tool 200 or tool 400 is positioned on the coupler. In certain embodiments, the tool can be affixed to the coupler neck so that the plunger release can be engaged on the coupler face.

Next, the cutout of the tool can be tightened around the coupler by turning the threaded clamps on the lower base at step 520. The tool can be securely engaged to the coupler in this manner.

Once the tool is securely engaged, at step 525 the plunger release can be positioned against the face of the coupler. This is achieved by turning the plunger release in the threaded plunger release port so that the release socket moves toward the plunger face.

At step 530, the release socket applies pressure to the coupler. In certain embodiments, the release socket rim is sized to match, or be close in size, to the release ring of the coupler, so that as the release socket engages the coupler on the release ring only. The release socket rim applies pressure against the release ring.

The pressure applied by the tool against the coupler, causes the coupler to open at step 535. In certain embodiments, this can include the release of pressure from the hydraulic circuit. At step 540 the tool is removed from the coupler, and the method ends at step 545.

Based on the foregoing, it can be appreciated that a number of embodiments, preferred and alternative, are disclosed herein. For example, in an embodiment a tool comprises an upper brace, a lower brace, a cutout formed in the lower brace, and a plunger release engaged with the upper brace and aligned with the cutout in the lower brace. In an embodiment, the tool further comprises at least one support stand affixed on one end to the upper brace and affixed on the other end to the lower brace. In an embodiment, the tool further comprises a threaded plunger release port in the upper brace configured to accept the plunger release. In an embodiment, the tool further comprises at least one threaded clamp engaged with the lower brace and configured to tighten the cutout around a coupler. In an embodiment, the plunger release further comprises a handle, a threaded shaft extending from the handle, and a release socket on an end of the threaded shaft. In an embodiment, the release socket comprises a tubular body and a rim. In an embodiment, the rim of the release socket is sized to match a release ring of a coupler. In an embodiment, an overflow port configured on the tubular body of the release socket. In an embodiment, the lower brace further comprises a first side brace and a second side brace. In an embodiment, the tool includes a first inner edge profile with a partial circle cutout formed on the first side brace and a second inner edge profile with a partial circle cutout formed on the second side brace. In an embodiment, the first side brace and the second side brace are connected with at least one threaded clamp engaged with the lower brace and configured to tighten the cutout around a coupler.

In an embodiment, a tool comprises an upper brace, a lower brace, a cutout formed in the lower brace, the cutout being sized to engage a neck of a quick coupler, and a plunger release engaged with the upper brace and aligned with the cutout in the lower brace. In an embodiment, the plunger release is configured to engage a connection face of the quick coupler. In an embodiment, the quick coupler comprises an International Standards Organization (ISO) 16028 conforming coupler. In an embodiment, the tool further comprises a threaded plunger release port in the upper brace configured to accept the plunger release. In an embodiment, the tool further comprises at least one threaded clamp engaged with the lower brace and configured to tighten the cutout around the neck of the quick coupler. In an embodiment, the plunger release further comprises a handle, a threaded shaft extending from the handle, and a release socket on an end of the threaded shaft, wherein a diameter of a rim of the release socket is sized to nominally match a diameter of a release ring of the quick coupler. In an embodiment, the tool further comprises an overflow port configured on the release socket. In an embodiment, the lower brace further comprises a first side brace, and a second side brace, wherein the first side brace and the second side brace are connected with at least one threaded clamp engaged with the lower brace and configured to tighten the cutout around the quick coupler.

In an embodiment, a system comprises an upper brace, a lower brace, a cutout formed in the lower brace, the cutout being sized to engage a neck of a comprises an International Standards Organization (ISO) 16028 conforming coupler, and a plunger release engaged with the upper brace and aligned with the cutout in the lower brace.

It will be appreciated that variations of the above-disclosed and other features and functions, or alternatives thereof, may be desirably combined into many other different systems or applications. Also, various presently unforeseen or unanticipated alternatives, modifications, variations, or improvements therein may be subsequently made by those skilled in the art which are also intended to be encompassed by the following claims.

What is claimed is:

1. A tool comprising:
an upper brace;
a lower brace;
a cutout formed in the lower brace; and
a plunger release engaged with the upper brace and aligned with the cutout in the lower brace.

2. The tool of claim 1 further comprising:
at least one support stand affixed on one end to the upper brace and affixed on an other end to the lower brace.

3. The tool of claim 1 further comprising:
a threaded plunger release port in the upper brace configured to accept the plunger release.

4. The tool of claim 1 further comprising:
at least one threaded clamp engaged with the lower brace and configured to tighten the cutout around a coupler.

5. The tool of claim 1 wherein the plunger release further comprises:
a handle;
a threaded shaft extending from the handle; and
a release socket on an end of the threaded shaft.

6. The tool of claim 5 wherein the release socket comprises:
a tubular body; and
a rim.

7. The tool of claim 6 wherein the rim of the release socket is sized to nominally match a size of a release ring of a coupler.

8. The tool of claim 6 further comprising:
an overflow port configured on the tubular body of the release socket.

9. The tool of claim 1 wherein the lower brace further comprises:
a first side brace; and
a second side brace.

10. The tool of claim 9 further comprising:
a first inner edge profile with a partial circle cutout formed on the first side brace; and
a second inner edge profile with a partial circle cutout formed on the second side brace.

11. The tool of claim 10 wherein the first side brace and the second side brace are connected with at least one threaded clamp engaged with the lower brace and configured to tighten the cutout around a coupler.

12. A tool comprising:
an upper brace;
a lower brace;
a cutout formed in the lower brace, the cutout being sized to engage a neck of a quick coupler; and
a plunger release engaged with the upper brace and aligned with the cutout in the lower brace.

13. The tool of claim 12 wherein the plunger release is configured to engage a connection face of the quick coupler.

14. The tool of claim 12 wherein the quick coupler comprises an International Standards Organization (ISO) 16028 conforming coupler.

15. The tool of claim 12 further comprising:
a threaded plunger release port in the upper brace configured to accept the plunger release.

16. The tool of claim 12 further comprising:
at least one threaded clamp engaged with the lower brace and configured to tighten the cutout around the neck of the quick coupler.

17. The tool of claim 12 wherein the plunger release further comprises:
a handle;
a threaded shaft extending from the handle; and
a release socket on an end of the threaded shaft, wherein a diameter of a rim of the release socket is sized to nominally match a diameter of a release ring of the quick coupler.

18. The tool of claim 17 further comprising:
an overflow port configured on the release socket.

19. The tool of claim 12 wherein the lower brace further comprises:
a first side brace; and
a second side brace, wherein the first side brace and the second side brace are connected with at least one threaded clamp engaged with the lower brace and configured to tighten the cutout around the quick coupler.

20. A system comprising:
an upper brace;
a lower brace;
a cutout formed in the lower brace, the cutout being sized to engage a neck of a comprises an International Standards Organization (ISO) 16028 conforming coupler; and
a plunger release engaged with the upper brace and aligned with the cutout in the lower brace.
